(19) United States
(12) Patent Application Publication
(10) Pub. No.: US 2011/0131205 A1
(43) Pub. Date: Jun. 2, 2011

(54) SYSTEM AND METHOD TO IDENTIFY CONTEXT-DEPENDENT TERM IMPORTANCE OF QUERIES FOR PREDICTING RELEVANT SEARCH ADVERTISEMENTS

(75) Inventors: Rukmini Iyer, Los Altos, CA (US); Eren Manavoglu, Menlo Park, CA (US); Hema Raghavan, Arlington, MA (US)

(73) Assignee: Yahoo! Inc., Sunnyvale, CA (US)

(21) Appl. No.: 12/626,894

(22) Filed: Nov. 28, 2009

(51) Int. Cl. G06F 17/30

(52) U.S. Cl. 707/728; 707/E17.064

(57) ABSTRACT

An improved system and method for identifying context-dependent term importance of queries is provided. A query term importance model is learned using supervised learning of context-dependent term importance for queries and is then applied for advertisement prediction using term importance weights of query terms as query features. For instance, a query term importance model for query rewriting may predict rewritten queries that match a query with term importance weights assigned as query features. Or a query term importance model for advertisement prediction may predict relevant advertisements for a query with term importance weights assigned as query features. In an embodiment, a sponsored advertisement selection engine selects sponsored advertisements scored by a query term importance engine that applies a query term importance model using term importance weights as query features and inverse document frequency weights as advertisement features to assign a relevance score.

### CROSS-REFERENCE TO RELATED APPLICATIONS

The present invention is related to the following United States patent application, filed concurrently herewith and incorporated herein in its entirety:

“System and Method for Predicting Context-Dependent Term Importance of Search Queries,” Attorney Docket No. 2100.

### FIELD OF THE INVENTION

The invention relates generally to computer systems, and more particularly to an improved system and method to identify context-dependent term importance of search queries.

### BACKGROUND OF THE INVENTION

Although supervised learning has been used for natural language queries to identify the importance of terms to retrieve text such as newspaper articles (see M. Bendersky and W. B. Croft, Discovering Key Concepts in Verbose Queries, In SIGIR '08, 2008), web queries do not follow rules of natural language, and term weights for web queries in traditional search engines and information retrieval (IR) are typically derived in a context-independent fashion. Standard information retrieval schemes of vector similarity, query likelihood from language models or probabilistic ranking approaches use term weighting schemes that typically ignore the query context. For example, an input query in the first pass of retrieval is typically represented using the count of the terms in the query and a context-independent or query-independent weight which denotes the term importance in the query. Traditional vector-space and language modeling retrieval techniques use term-frequency (TF), and/or document-frequency (DF) as an unsupervised technique to learn query weights. In vector similarity approaches, inverse document frequency (IDF) on the document index is very useful as a context-independent term weight. See, for example, G. Salton and C. Buckley, Term Weighting Approaches in Automatic Text Retrieval, Technical report, Ithaca, N.Y., USA, 1987. Context is typically derived by either using phrases in the query or by using higher order n-grams in language model formulations of retrieval. See, for example, J. M. Ponte and W. B. Croft, A Language Modeling Approach to Information Retrieval, In SIGIR ACM, 1998.

While IDF gives a reasonable signal for term importance, there are many examples in advertisement retrieval where the importance of the query terms needs to be completely derived from the context. Consider, for instance, the query “perl cookbook”. The IDF term weight for “cookbook” may be higher than the IDF term weight for “perl”, but the term “perl” is more important than “cookbook” in this query. In most queries, one or more terms in the query are necessarily “required” to be present in any document that is relevant to the query. While users' who are aware of advanced features of a search engine may typically use operators that indicate which terms must be present, or terms that must co-occur as a phrase, most users do not use such features, partly because they are cumbersome, but also in part because one can typically find some document that matches all the terms in a query in web-search because of the size and breadth of the web.

Unlike web search, where there are billions of documents and the web pages provide extensive context, in the case of sponsored search, term weights on the query terms are even more important because the advertisement is fairly short and the advertisement corpus is also much smaller. The advertiser typically provides a title, a small description, and a set of keywords or key phrases to identify an advertisement. Given a short document, it is harder to ask for all the terms in the query to be observed in the document. Therefore, knowing which of the query terms are important for the user to spot in the advertisement so as to induce a click or response from the user is important for preserving the quality of the advertisements that are shown to the user.

What is needed is a way to identify which of the search query terms are important for use in selecting an advertisement that is relevant to a user's interest. Such a system and method should be able to identify context-dependent importance of terms of a search query to provide more relevant advertisements.

### SUMMARY OF THE INVENTION

Briefly, the present invention may provide a system and method to identify context-dependent term importance of search queries. In various embodiments, a client computer may be operably connected to a search server and an advertisement server. The advertisement server may be operably coupled to an advertisement serving engine that may include a sponsored advertisement selection engine that selects sponsored advertisements scored by a query term importance engine that applies a query term importance model for advertisement prediction. The sponsored advertisement selection engine may be operably coupled to a query term importance engine that applies a query term importance model for advertisement prediction that uses term importance weights of query terms as query features and inverse document frequency weights of advertisement terms as advertisement features to assign a relevance score to sponsored advertisements. The advertising serving engine may rank sponsored advertisements in descending order by score and send a list of sponsored advertisements with the highest scores to the client computer for display in the sponsored advertisement area of the search results web page. Upon receiving the sponsored advertisements, the client computer may display the sponsored advertisements in the sponsored advertisement area of the search results web page.

In general, the present invention may learn a query term importance model using supervised learning of context-dependent term importance for queries and apply the query term importance model for advertisement prediction that uses term importance weights of query terms as query features. To do so, a query term importance model may learn context-dependent term importance weights of query terms from training queries to predict term importance weights for terms of an unseen query. The weights of term importance may be applied as query features in sponsored advertising applications. For instance, a query term importance model for advertisement prediction may predict relevant advertisements for a query with term importance weights assigned as query features. Or a query term importance model for query rewriting may predict rewritten queries that match a query with term importance weights assigned as query features.

To predict rewritten queries that match a query with term importance weights assigned as query features, a search query sent by a client device to obtain search results may be received, and term importance weights may be assigned to the query as query features using the query term importance model. Matching rewritten queries may be determined by a term importance model for query rewriting that uses term importance weights as query features for the query and the rewritten queries to assign a match type score. Matching rewritten queries may be sent to a sponsored advertisement selection engine to select sponsored advertisements for display in the sponsored advertisement area of the search results web page.

To predict relevant advertisements for a query with term importance weights assigned as query features, a search query sent by a client device to obtain search results may be received, and term importance weights may be assigned to the query as query features using the query term importance model. Relevant sponsored advertisements may be determined by a term importance model for advertisement prediction that uses term importance weights as query features and inverse document frequency weights for advertisement terms as advertisement features to assign a relevance score. The sponsored advertisements may be ranked in descending order by relevance score. And a list of sponsored advertisement with the highest scores may be sent to the client computer for display in the sponsored advertisement area of the search results web page. Upon receiving the update of sponsored advertisements, the client computer may display the updated sponsored advertisements in the sponsored advertisement area of the search results web page.

Advantageously, the present invention may use supervised learning of context-dependent term importance for learning better query weights for search engine advertising where the advertisement document may be short and provide scant context in the title, small description, and set of keywords or key phrases that identify the advertisement. The query term importance model predicts the importance of a term in search engine queries better than IDF for advertisement retrieval tasks in a sponsored search system, including query rewriting and selecting more relevant advertisements presented to a user. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components to identify context-dependent term importance of search queries, in accordance with an aspect of the present invention;

FIG. 3 is a flowchart generally representing the steps undertaken in one embodiment for generating a query term importance model that assigns context-dependent term importance weights to query terms of queries, in accordance with an aspect of the present invention;

FIG. 4 is a flowchart generally representing the steps undertaken in one embodiment for applying the term importance model for advertisement prediction to determine matching advertisements, in accordance with an aspect of the present invention;

FIG. 5 is a flowchart generally representing the steps undertaken in one embodiment for generating a query term importance model for advertisement prediction using term importance weights assigned as query features, in accordance with an aspect of the present invention;

FIG. 6 is a flowchart generally representing the steps undertaken in one embodiment for training a query term importance model to predict relevant advertisements using term importance weights assigned as query features to queries of the training sets of query-advertisement pairs with a relevance score, in accordance with an aspect of the present invention;

FIG. 7 is a flowchart generally representing the steps undertaken in one embodiment for calculating similarity measures of query-advertisement pairs using term importance weights assigned as query features to queries in the training sets of query-advertisement pairs, in accordance with an aspect of the present invention;

FIG. 8 is a flowchart generally representing the steps undertaken in one embodiment for applying the term importance model for query rewriting to determine matching rewritten queries for selection of sponsored advertisements, in accordance with an aspect of the present invention;

FIG. 9 is a flowchart generally representing the steps undertaken in one embodiment for generating a query term importance model for query rewriting using term importance weights assigned as query features, in accordance with an aspect of the present invention; and

FIG. 10 is a flowchart generally representing the steps undertaken in one embodiment for training a query term importance model to predict matching rewritten queries using term importance weights assigned as query features to queries of the training sets of query pairs of an original query and a rewritten query with a match type score, in accordance with an aspect of the present invention.

### DETAILED DESCRIPTION

### Exemplary Operating Environment

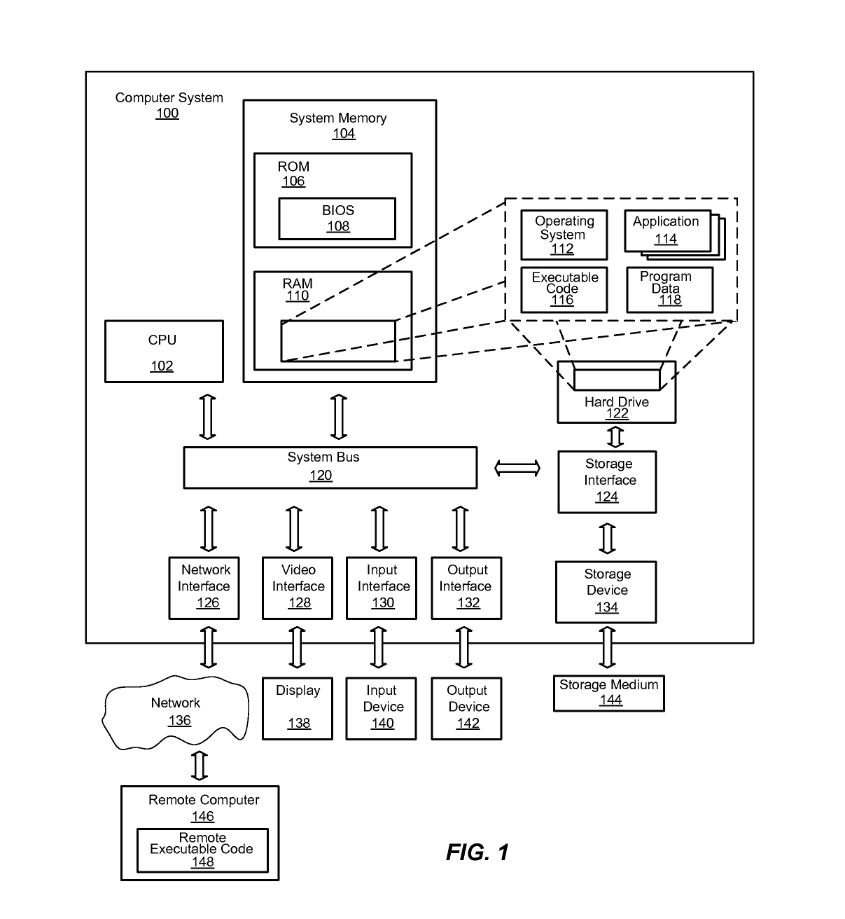

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Identifying Context-Dependent Term Importance of Search Queries

The present invention is generally directed towards a system and method to identify context-dependent term importance of search queries. In general, the present invention may learn a query term importance model using supervised learning of context-dependent term importance for queries and apply the query term importance model for advertisement prediction that uses term importance weights of query terms as query features. To do so, a query term importance model may learn context-dependent term importance weights of query terms from training queries to predict term importance weights for terms of an unseen query. As used herein, context-dependent term importance of a query means an indication or annotation of the importance of a term of a query by an annotator with a category or score of term importance in the context of the query. The weights of term importance may be applied as query features in sponsored advertising applications. For instance, a query term importance model for advertisement prediction may predict relevant advertisements for a query with term importance weights assigned as query features. Or a query term importance model for query rewriting may predict rewritten queries that match a query with term importance weights assigned as query features.

As will be seen, the query term importance model may predict the importance of a term in search engine queries better than IDF for advertisement retrieval tasks in a sponsored search system. As used herein, a sponsored advertisement means an advertisement that is promoted typically by financial consideration and includes auctioned advertisements display on a search results web page. As will be understood, the various block diagrams, flow charts and scenarios described herein are only examples, and there are many other scenarios to which the present invention will apply.

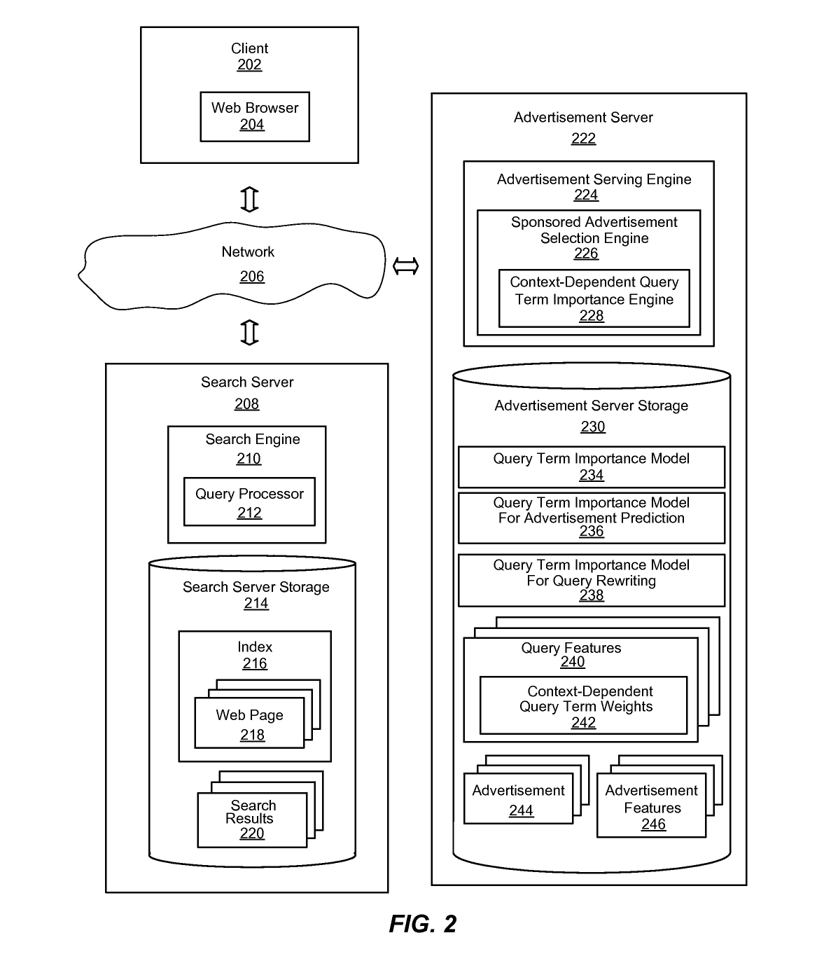

Turning to FIG. 2 of the drawings, there is shown a block diagram generally representing an exemplary architecture of system components to identify context-dependent term importance of search queries. Those skilled in the art will appreciate that the functionality implemented within the blocks illustrated in the diagram may be implemented as separate components or the functionality of several or all of the blocks may be implemented within a single component. For example, the functionality for the context-dependent query term importance engine 228 may be included in the same component as the sponsored advertisement selection engine 226 as shown. Or the functionality of the context-dependent query term importance engine 228 may be implemented as a separate component from the sponsored advertisement selection engine 226. Moreover, those skilled in the art will appreciate that the functionality implemented within the blocks illustrated in the diagram may be executed on a single computer or distributed across a plurality of computers for execution.

In various embodiments, a client computer 202 may be operably coupled to a search server 208 and an advertisement server 222 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query and functionality for sending the query request to a server to obtain a list of search results. The web browser 204 may also be any type of interpreted or executable software code such as a kernel component, an application program, a script, a linked library, an object with methods, and so forth. The web browser may alternatively be a processing device such as an integrated circuit or logic circuitry that executes instructions represented as microcode, firmware, program code or other executable instructions that may be stored on a computer-readable storage medium. Those skilled in the art will appreciate that the web browser may also be implemented within a system-on-a-chip architecture including memory, external interfaces and an operating system.

The search server 208 may be any type of computer system or computing device such as computer system 100 of FIG. 1. In general, the search server 208 may provide services for processing a search query and may include services for requesting a list of sponsored advertisements from an advertisement server 222 to be sent to the web browser 204 executing on the client 202 for display with the search results of query processing. In particular, the search server 208 may include a search engine 210 for receiving and responding to search query requests. The search engine 210 may include a query processor 212 that parses the query into query terms and may also expand the query with additional terms. Each of these components may also be any type of executable software code such as a kernel component, an application program, a linked library, an object with methods, a script or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. The search server 208 may be operably coupled to search server storage 214 that may store an index 216 of crawled web pages 218 that may be searched using keywords of the search query to find web pages that may be provided in the search results. The web page storage may also store search result web pages 220 that provide a list of search results with addresses of web pages such as Uniform Resource Locators (URLs).

The advertisement server 222 may be any type of computer system or computing device such as computer system 100 of FIG. 1. The advertisement server 222 may provide services for providing a list of advertisements that may be sent to the web browser 204 executing on the client 202 for display with the search results of query processing. The advertisement server 222 may include an advertisement serving engine 224 that may receive a request with a query to serve a list of advertisements for display with the search results of query processing. The advertisement serving engine 224 may include a sponsored advertisement selection engine 226 that may select the list of advertisements. The sponsored advertisement selection engine 226 may include a context-dependent query term importance engine 228 that applies a query term importance model with term importance weights of query terms as query features for predicting relevant search advertisements and/or for query rewriting. The advertisement server 222 may be operably coupled to a database of advertisements such as advertisement server storage 230 that may store a query term importance model 234 that learns term importance weights assigned to query terms of queries annotated by categories of context-dependent term importance. The advertisement server storage 230 may store a query term importance model for advertisement prediction 236 with term importance weights assigned as query features used to predict relevant advertisements for a query. The advertisement server storage 230 may store a query term importance model for query rewriting 238 with term importance weights assigned as query features used to predict rewritten queries that match a query. The advertisement server storage 230 may store query features 240 that include context-dependent term importance weights 242 of a query, and the advertisement server storage 230 may also store any type of advertisement 244 that may have associated advertisement features 246. When the advertisement server 222 may receive a request with a query to serve a list of advertisements for display with the search results, the query term importance model for advertisement prediction may be used to determining matching advertisements for the query features that include context-dependent term importance weights of the query and for the advertisement features.

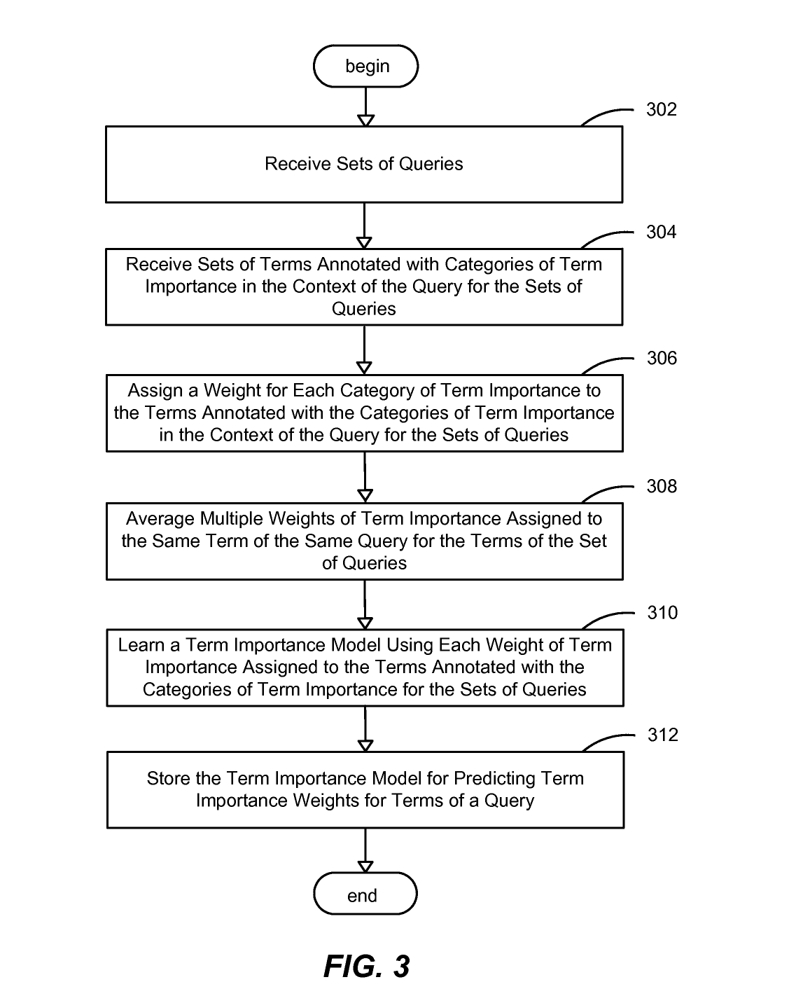

FIG. 3 presents a flowchart generally representing the steps undertaken in one embodiment for generating a query term importance model that assigns context-dependent term importance weights to query terms of queries. A set of queries may be received at step 302, and sets of terms annotated with categories of term importance in the context of the query may be received at step 304 for the sets of queries. The queries in the set may be of different lengths ranging between 2 and 7 or more terms. In an embodiment, there may be several sets of terms for the set of queries annotated by different sources with categories of term importance. For instance, different annotators may label each of the several sets of terms for the set of queries. In a particular embodiment, each annotator may mark each query term with the labels: Unimportant, Important, Required or Super-important. Additionally, an annotator may mark named entities in the following categories: People Names (N), Product Names (P), Locations (G), Titles (T), Organizations (O), and Lyrics (L). For example, a query may be labeled as follows:

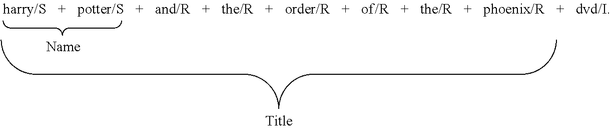

Note that all the terms in this example are important for preserving the meaning of the original query and therefore are marked with a label of at least Important. The phrase ‘harry potter and the order of the phoenix’ is labeled Required since it forms a sub-query for which ads would be considered relevant. Finally, ‘harry potter’ is labeled Super-important because any advertisement shown for this query must contain the words ‘harry’ and ‘potter’.

At step 306, a weight may be assigned for each category of term importance to the terms annotated with the categories of term importance in the context of the query for the set of queries. For example, a weight of 0, 0.3, 0.7, and 1.0 may be respectively assigned for categories Unimportant, Important, Required or Super-important. At step 308, multiple weights of term importance assigned to the same term of the same query may be averaged.

A term importance model may be learned at step 310 using term importance weights assigned to query terms of queries annotated by categories of context-dependent term importance, and the term importance model may be stored at step 312 for predicting term importance weights for terms of a query. The weights of term importance may be applied as query features in sponsored advertising applications. For instance, a query term importance model for advertisement prediction may predict relevant advertisements for a query with term importance weights assigned as query features. Or a query term importance model for query rewriting may predict rewritten queries that match a query with term importance weights assigned as query features.

Those skilled in the art will appreciate that the term importance model may include other features such as query length, IDF, Point-wise Mutual Information (PMI), bid term frequency, categorization features, named entities, IR rank moves, single term query ratio, Part-Of-Speech, stopword removal, character count ratio, and so forth. The intuition behind the query length feature is that terms in shorter queries are more likely to be important, while long queries tend to have some function words that are typically unimportant. The single term query ratio feature may measure how important a term is by seeing how often it appears by itself as a search term. To calculate the single term query ratio, the number of occurrences of a term as a whole query may be divided by the number of queries that have the term among other terms. Stopword removal may be implemented using a manually constructed stopword list in order to determine whether a term is a content term or not. Part-of-speech (POS) information of each word in the query may be used as a feature since words in some POS are likely to be more important in a query. For named entities features, a binary variable may be used to indicate presence/absence of a named entity in a dictionary. Dictionaries may have higher precision that may be added to the higher recall of the model. Character count ratio may be calculated as the number of characters in a term divided by the number of all the characters except white spaces in a query. Sometimes longer terms tend to imply multiple meanings to be more important in a query. This feature may also count for spacing errors in writing queries.

IDF for the IDF features may be calculated in an embodiment on about 30 billion queries from query logs of a major search engine as follows:

$$IDF ( {w}_{i} ) = log ( \frac{n}{max ( DF ( {w}_{i} ) , {min}_{k ∈ V} ( DF ( {w}_{k} ) ) )} ) ,$$

where N is the total number of queries and V is the set of all the terms in the query logs. PMI for the PMI features may be computed as:

$$log \frac{p ( {w}_{1} , {w}_{2} )}{p ( {w}_{1} ) p ( {w}_{2} )} ,$$

where p(w₁,w₂) is the joint probability of observing both words w₁ and w₂ in the query logs and p(w₁)p(w₂) is the probability of observing word w₁(w₂) in the query logs. All possible pairs of words in a query may be considered to capture distant dependencies. Term order may be preserved to capture semantic differences. For example, “bank america” gives a signal that the query is about “bank of america”, but “america bank” does not. Given a term in a query, average PMI, PMI with the left word, and PMI with the right word may be used.

Bid term frequency may be calculated by how many times a term is observed in the bid phrase field of advertisements in the corpus which may represent the number of products associated with a given term. For categorization features, categorization labels may be generated by an automatic query classifier which labels segments with their category information such as person name, place-name etc. When a term is a part of a named entity, it is unlikely that the term can be discarded without hurting search results in most cases. For each segment, a categorization score and the ratio of the length of the segment to the rest of the query may be used as categorization features.

IR rank moves may provide a measure of how important a term is in normal information retrieval. The top-10 search results may be obtained in an embodiment by dropping each term in the query and issuing the resulting sub-query to a major search engine. Assuming the top-10 search results with the original query represents “the truth”, the normalized discounted cumulative gain (NDCG) of each sub-query may be calculated as:

$${nDCG}_{p} = \frac{{DCG}_{p}}{{IDCG}_{p}} , \\ where$$

$${DCG}_{p} = {\sum }_{i = 1}^{p} \frac{{2}^{{rel}_{i}} - 1}{{log}_{2} ( 1 + i )} .$$

is the ideal DCGₚ position p and relᵢ=p−i−1. If there are more than 10 search results, the p=10 may be used; otherwise p is the result list size.

In various embodiments, there may be different regression-based machine learning models used for the term importance model. For instance, Gradient Boosted Decision Trees (GBDT) may be used in a regression-based machine learning model and may perform well given its capability of learning conjunctions of features. In various other embodiments, Linear Regression (LR), REP Tree (REPTree) that builds a decision/regression tree using information gain/variance reduction and prunes it using reduced-error pruning with backfitting, and Neural Network (NNet) may be alternatively used in a regression-based machine learning model.

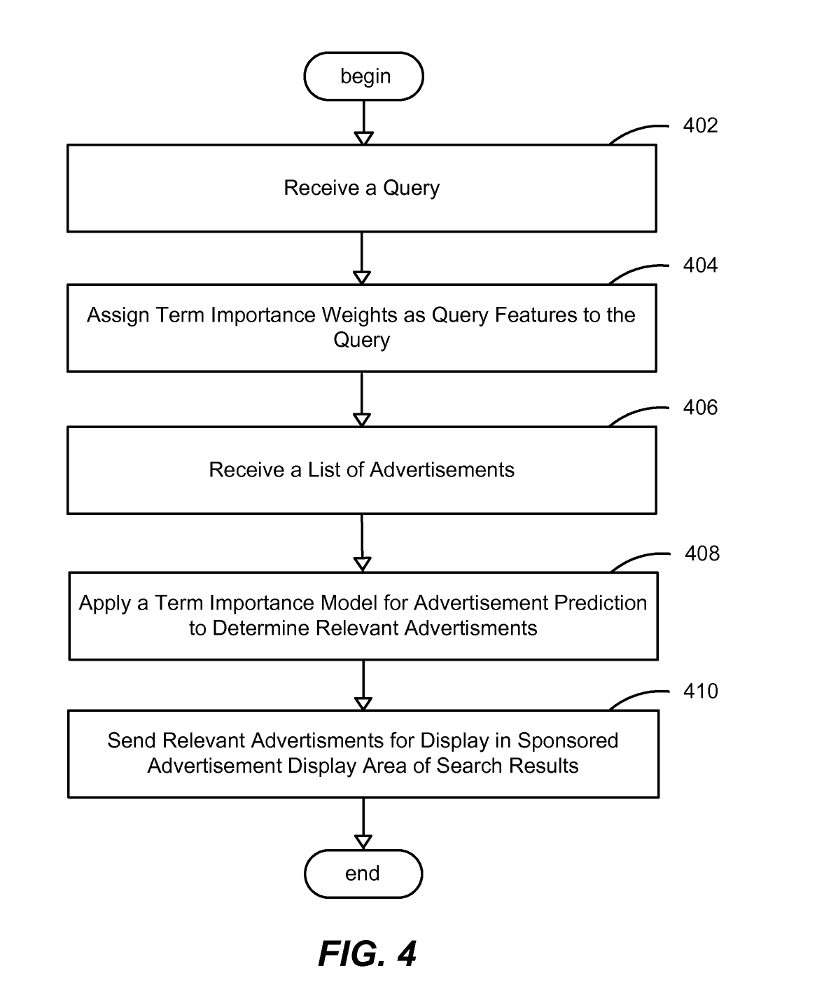

FIG. 4 presents a flowchart generally representing the steps undertaken in one embodiment for applying the term importance model for advertisement prediction to determine matching advertisements. At step 402, a query may be received. In an embodiment, a search query sent by a client device to obtain search results may be received by a search engine. At step 404, term importance weights may be assigned to the query as query features. In an embodiment, term importance weights for the query may be assigned using the query term importance model described in conjunction with FIG. 3. At step 406, a list of advertisements may be received. In an embodiment, a candidate list of advertisements for the query may be received. At step 408, a term importance model for advertisement prediction may be applied to determine relevant advertisements. For instance, the advertisement server may select a list of sponsored advertisements using term importance weights as query features and inverse document frequency weights for advertisement terms as advertisement features. The term importance model for advertisement prediction may predict relevance for query-advertisement pairs. At step 410, a list of relevant advertisements may then be sent from the advertisement server to the client device for display in the sponsored advertisement area of the search results web page.

In various embodiments, the term importance model may be applied in a statistical retrieval framework to predict relevance of advertisements for queries. Considering that each advertisement represents a document, a probability of relevance, R, may be computed for each document, D, given a query, Q, by the equation:

$$p ( R \vert D ) = \frac{p ( D \vert R ) p ( R )}{p ( D )} .$$

Consider θ_{Q} to denote a measure of how words are distributed in relevant documents. Assuming that every document, D, has a distribution across all words in the vocabulary, V, represented by the vector, d₁, . . . d_{|V|}, the numerator term p(D|R) may be calculated by the equation:

$$p ( D \vert {θ}_{Q} ) = {\prod }_{i = 1}^{V} p ( {d}_{i} \vert {θ}_{Q} ) = {\prod }_{i = 1}^{V} {\sum }_{j} p ( {z}_{i} = j \vert {θ}_{Q} ) p ( {d}_{i} \vert {z}_{i} = j ) ,$$

where R≡θ_{Q}. Note that a latent variable zᵢ is introduced for every term in the vocabulary, V, which is dependent on the entire query, Q. This latent variable represents the importance of a term in a query. Given a distribution over this latent variable, the document probability is only dependent on the latent variable. The other numerator term, p(θ_{Q}) where R≡θ_{Q}, can be modeled as a prior probability of relevance for a particular query. Note that p(θ_{Q}) is constant across all documents and is not needed for ranking documents. Finally, the denominator term, p(D), can be modeled by the equation,

$$p ( D ) = {\prod }_{i = 1}^{V} p ( {d}_{i} ) = {\prod }_{i = 1}^{V} p ( {d}_{i} \vert {z}_{i} = 0 ) ,$$

assuming that every document, D, has a distribution across all words in the vocabulary, V, represented by the vector, d₁, . . . d_{|V|}, but that all words are unimportant in the limit across all the possible queries.

To make document retrieval efficient for a query,

$$\frac{p ( D \vert Q )}{p ( D )}$$

may be simplified as:

$$\frac{p ( D \vert Q )}{p ( D )} = {\prod }_{i = 1}^{V} [ p ( {z}_{i} = 1 \vert Q ) p ( {d}_{i} \vert {z}_{i} = 1 ) + p ( {z}_{i} = 0 \vert Q ) p ( {d}_{i} \vert {z}_{i} = 0 ) ] / p ( {d}_{i} \vert {z}_{i} = 0 ) .$$

Vocabulary terms present in the query are the only ones with a non-zero p(zᵢ=1|Q). Given that assumption, all terms in the vocabulary that are not in the query will contribute 1 to the product. All terms in the query that are required or important with p(zᵢ=1|Q)=1 will enforce the presence of the term in the document, since p(dᵢ|zᵢ=1)=0. In other words, for every term in the query that is not present in the document, the document will incur a penalty p(zᵢ=0|Q) which can be zero in the limit. Importantly, the statistical retrieval framework will support query expansions and term translations where p(zᵢ|Q) can be predicted for terms zᵢ not in the original query.

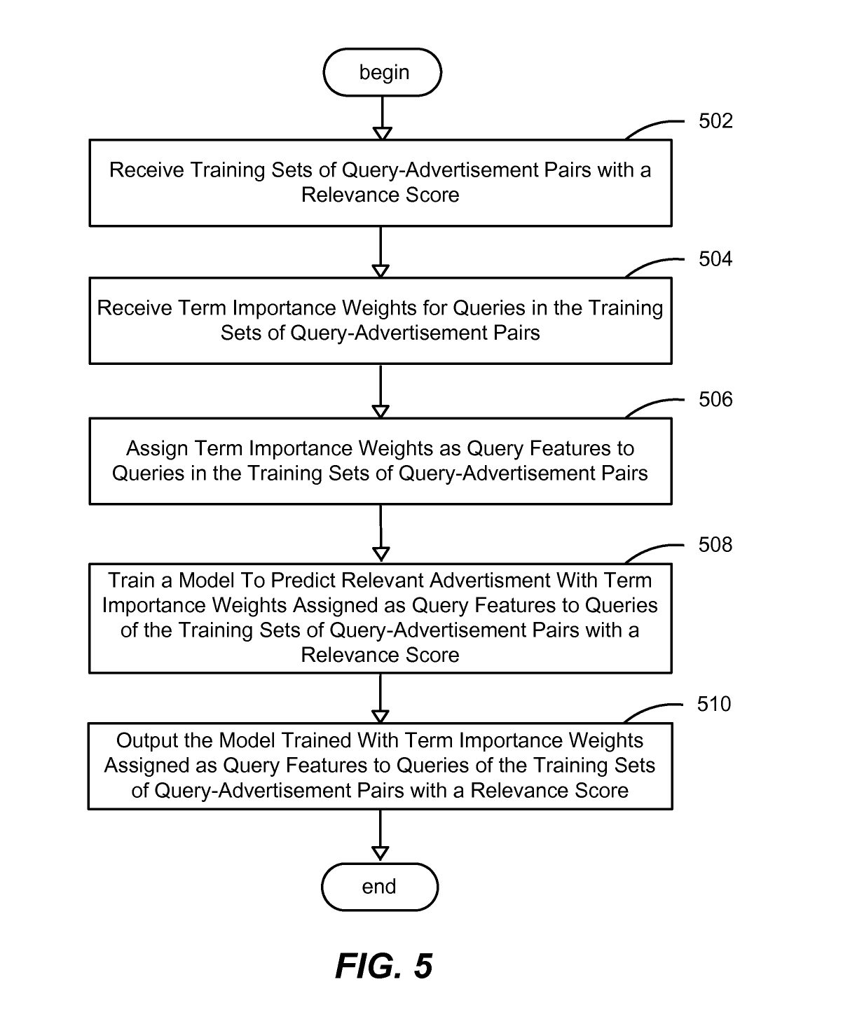

In various other embodiments, the term importance model may be applied to generate a query term importance model for advertisement prediction using supervised learning. FIG. 5 presents a flowchart generally representing the steps undertaken in one embodiment for generating a query term importance model for advertisement prediction using term importance weights assigned as query features. At step 502, training sets of query-advertisement pairs with a relevance score assigned from annotators assessment of relevancy may be received. For instance, advertisements obtained in response to queries were submitted to human editors to judge. Editors who were well trained for the task marked each pair with a label of ‘Bad’, ‘Fair’, ‘Good’, ‘Excellent’ or ‘Perfect’ according to the relevancy of the ad to the query. In addition, term importance weights for queries in the training sets of query-advertisement pairs may be received at step 504. The term importance weights may be assigned at step 506 as query features for queries in the training sets of query-advertisement pairs.

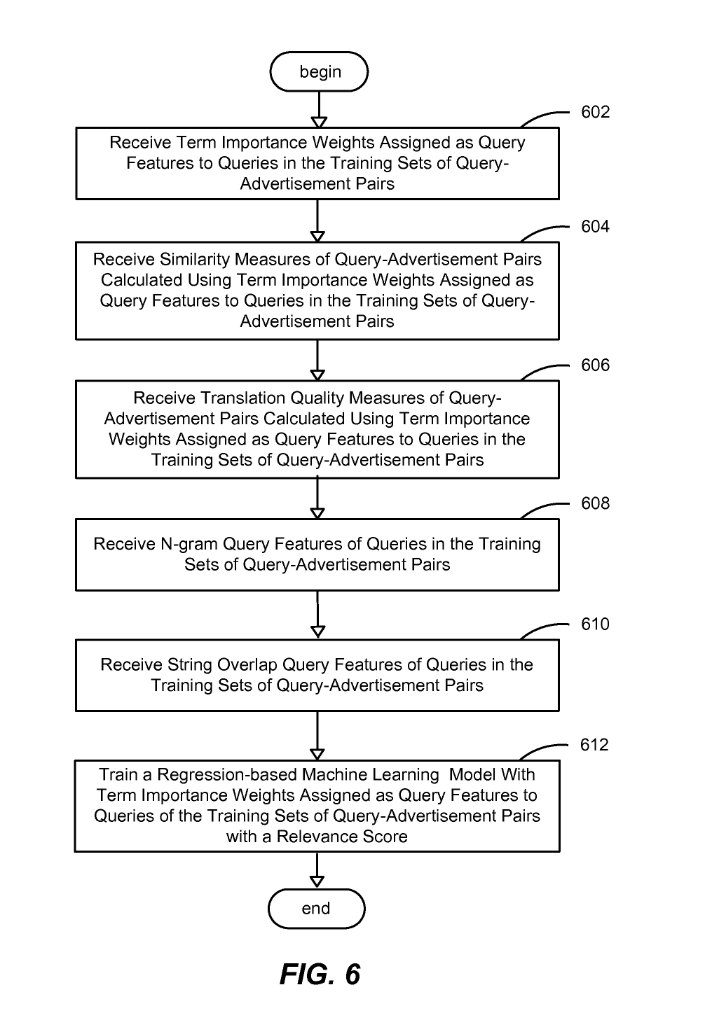

At step 508, a model may be trained to predict relevant advertisements using term importance weights assigned as query features to queries of the training sets of query-advertisement pairs with a relevance score. The steps for training the model are described in further detail below in conjunction with FIG. 6. The model trained using term importance weights assigned as query features to queries of the training sets of query-advertisement pairs with a relevance score may then be output at step 510. In an embodiment, the model may be stored in storage such as advertisement server storage.

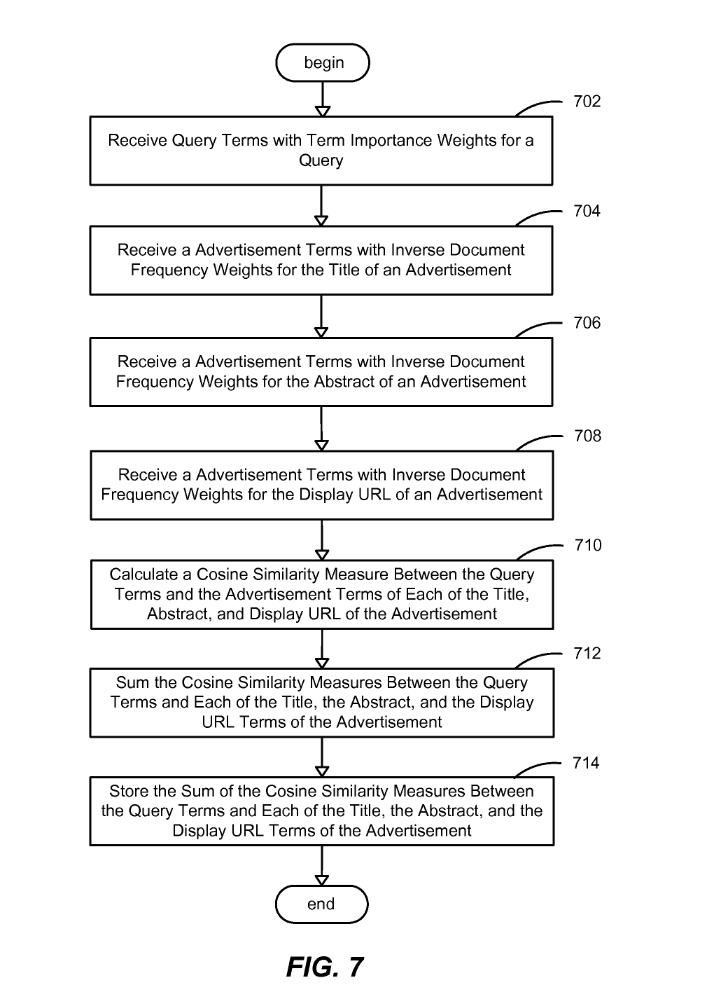

FIG. 6 presents a flowchart generally representing the steps undertaken in one embodiment for training a query term importance model to predict relevant advertisements using term importance weights assigned as query features to queries of the training sets of query-advertisement pairs with a relevance score. At step 602, term importance weights assigned as query features to queries in the training sets of query-advertisement pairs may be received. Similarity measures of query-advertisement pairs calculated using term importance weights assigned as query features to queries in the training sets of query-advertisement pairs may be received at step 604. The steps for calculating similarity measures of query-advertisement pairs using term importance weights assigned as query features to queries in the training sets of query-advertisement pairs may be described below in conjunction with FIG. 7.

Translation quality measures of query-advertisement pairs calculated using term importance weights assigned as query features to queries in the training sets of query-advertisement pairs may be received at step 606. In various embodiments, there may be several translation quality measures calculated for each query-advertisement pair, including a translation quality measure for a query-advertisement pair, Tr(Query|Advertisement), a translation quality measure for a query-advertisement abstract pair, Tr(Query|Abstract), and a translation quality measure for a query-advertisement title pair, Tr(Query|Title).

A translation quality measure may be calculated as follows:

$$Tr ( Q \vert A ) = {( {\prod }_{{q}_{i} ∈ Q} {max}_{{a}_{j} ∈ A} ( p ( {q}_{i} \vert {a}_{j} ) , ɛ ) )}^{\frac{1}{\vert Q \vert}}$$

where, p(qᵢ,aⱼ) is a probabilistic word translation table that was learned by taking a sample of queries of length greater than 5 and querying a web-search engine. A parallel corpus used to train the dictionary consisted of pairs of summaries of the top 2 web search results of over 400,000 queries. In an embodiment, the Moses machine translation system, known to those skilled in the art, may be used (see H. Hoang, A. Birch, C. Callison-burch, R. Zens, R. Aachen, A. Constantin, M. Federico, N. Bertoldi, C. Dyer, B. Cowan, W. Shen, C. Moran, and O. Bojar, Moses: Open Source Toolkit for Statistical Machine Translation, pages 177-180, 2007). Similarly, Tr(Query|Title) and Tr(Query|Abstract) were also calculated. To calculate translation quality, a basic symmetric probabilistic alignment (SPA) calculation known to those skilled in the art may be used and is described in J. D. Kim, R. D. Brown, P. J. Jansen, and J. G. Carbonell, Symmetric Probabilistic Alignment for Example-based Translation, In Proceedings of the Tenth Workshop of the European Assocation for Machine Translation (EAMT-05), May 2005.

In addition to these several translation quality measures, there may be a translation quality measure combined with a term importance weight as follows:

$$Tr ( Q \vert A ) = {( {\prod }_{{q}_{i} ∈ Q} {max}_{{a}_{j} ∈ A} ( p ( {q}_{i} \vert {a}_{j} ) * ti ( {q}_{i} ) , ɛ ) )}^{\frac{1}{\vert Q \vert}} ,$$

where ti(qᵢ) denotes term importance for qᵢ and ε is a very small value to avoid 0 production.

At step 608, n-gram query features of queries in the training sets of query-advertisement pairs may be received. At step 610, string overlap query features of queries in the training sets of query-advertisement pairs may be received. And a regression-based machine learning model may be trained with term importance weights assigned as query features to queries of the training sets of query-advertisement pairs with a relevance score at step 612. The model may be trained in various embodiments using boosting that combines an ensemble of weak classifiers to form a strong classifier. For instance, boosting may be performed by a greedy search for a linear combination of classifiers, implemented as one-level decision trees of discrete and continuous attributes, by overweighting the examples that are misclassified by each classifier. In an embodiment, the system may be trained to predict binary relevance by considering the label ‘Bad’ as ‘Irrelevant’ and the other labels of ‘Fair’, ‘Good’, ‘Excellent’ and ‘Perfect’ as ‘Relevant’. In an embodiment, the harmonic mean of precision and recall, F1, may be used as a training metric that take into account both precision and recall. The objective in using this metric is to achieve the largest possible F1 by finding a threshold that gives the highest F1 in training the model on the training set.

FIG. 7 presents a flowchart generally representing the steps undertaken in one embodiment for calculating similarity measures of query-advertisement pairs using term importance weights assigned as query features to queries in the training sets of query-advertisement pairs. Query terms with term importance weights assigned as query features to a query may be received at step 702. Advertisement terms with inverse document frequency weights may be received at step 704 for a title of an advertisement; advertisement terms with inverse document frequency weights may be received at step 706 for an abstract of an advertisement; and advertisement terms with inverse document frequency weights may be received at step 708 for a display URL of an advertisement.

At step 710, a cosine similarity measure may be calculated between the query terms and the advertisement terms of each of the title, abstract, and the display URL of the advertisement. In an embodiment, a cosine similarity measure may be calculated between a query term vector and an advertisement term vector of advertisement terms of the title of the advertisement; a cosine similarity measure may be calculated between a query term vector and an advertisement term vector of advertisement terms of the abstract of the advertisement; and a cosine similarity measure may be calculated between a query term vector and an advertisement term vector of advertisement terms of the display URL of the advertisement. At step 712, a cosine similarity measure between the query and the advertisement may be calculated by summing the cosine similarity measures between the query terms and the advertisement terms of each of the title, abstract, and the display URL of the advertisement. And the cosine similarity measure between the query and the advertisement may be stored at step 714, for instance, as a query feature of the query.

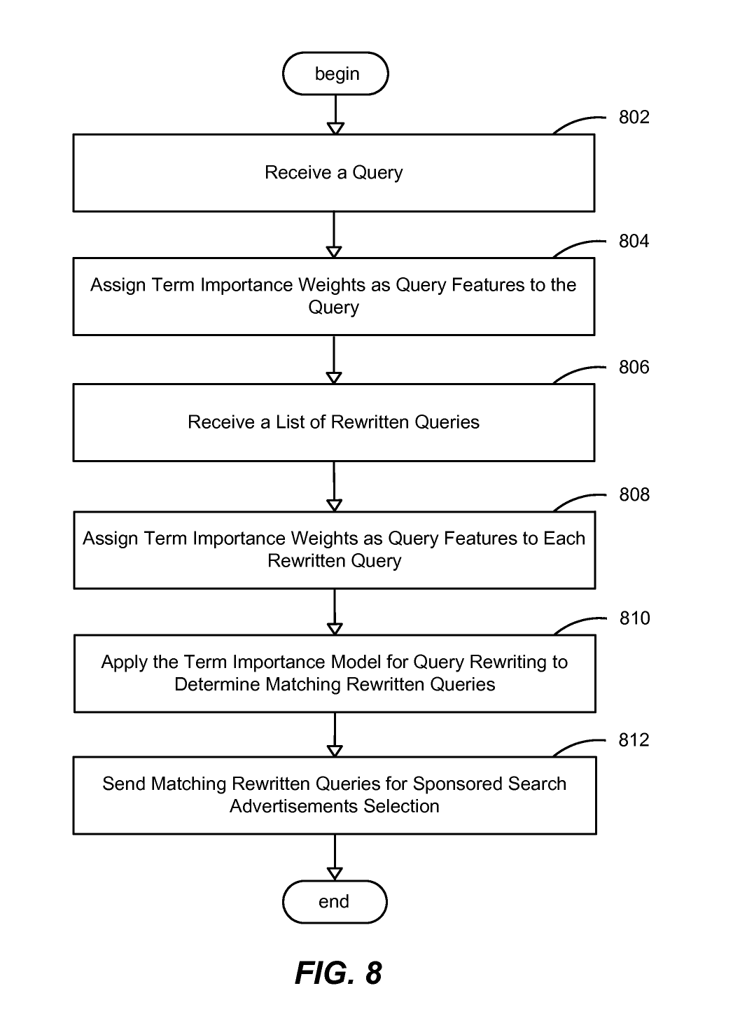

FIG. 8 presents a flowchart generally representing the steps undertaken in one embodiment for applying a term importance model for query rewriting to determine matching rewritten queries for selection of sponsored search advertisements. Given a query q1, it is rewritten as query q2, and “advance match” or “broad match” applications in search engine advertising may retrieve advertisements with the bidded-phrase q2 in response to query q1. Accordingly, a query may be received at step 802, and term importance weights may be assigned at step 804 as query features of the query. At step 806, a list of rewritten queries may be received. In an embodiment, the list of rewritten queries may be generated by query expansion of the query that adds, for example, synonymous terms to query terms.

At step 810, a term importance model for query rewriting may be applied to determine matching rewritten queries. And at step 812, matching rewritten queries may be sent for selection of sponsored search advertisements. In an embodiment, the context-dependent query term importance engine 228 may identify context-dependent term importance of query terms used for query rewriting and send matching rewritten queries to the sponsored advertisement selection engine 226. The sponsored advertisement selection engine may select a ranked list of sponsored advertisements and send the list of sponsored advertisements to a client device for display in the sponsored advertisements area of the search results page.

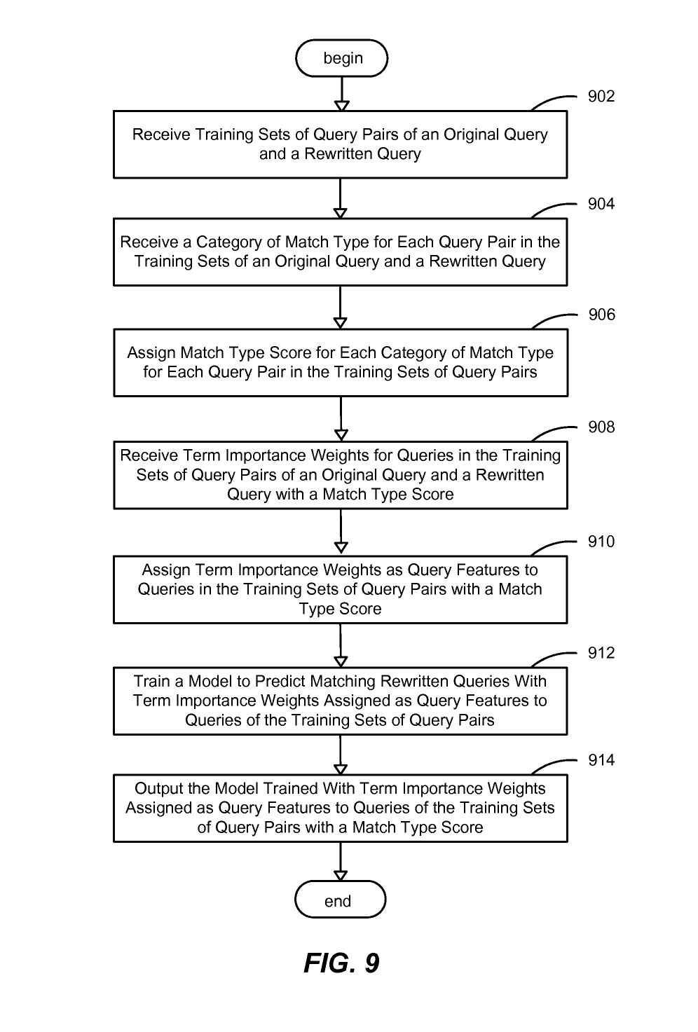

FIG. 9 presents a flowchart generally representing the steps undertaken in one embodiment for generating a query term importance model for query rewriting using term importance weights assigned as query features. Training sets of query pairs of an original query and a rewritten query may be received at step 902, and a category of match type may be received at step 904 for each query pair in the training sets of query pairs of an original query and a rewritten query. In an embodiment, a query pair may be annotated by different sources with a category of match type. For instance, different annotators may label each of the query pairs with a category of match type. Pairs of an original query, q1, and a rewritten query, q2, may be annotated from an assessment by annotators as one of four match types: Precise Match, Approximate Match, Marginal Match and Clear Mismatch. In an embodiment, this may be simplified by mapping the four categories of match type into two categories, where the first two categories, Precise Match and Approximate Match, correspond to a “match” and the last two categories, Marginal Match and Clear Mismatch, correspond to a mismatch.

At step 906, a match type score may be assigned for each category of match type for each query pair in the training sets of query pairs of an original query and a rewritten query. For example, a match type score of 0, 0.3, 0.7, and 1.0 may be respectively assigned for categories of Clear Mismatch, Marginal Match, Approximate Match and Precise Match. In an embodiment where a query pair may be annotated by different sources with a category of match type, multiple match type scores assigned to the same query pair may be averaged.

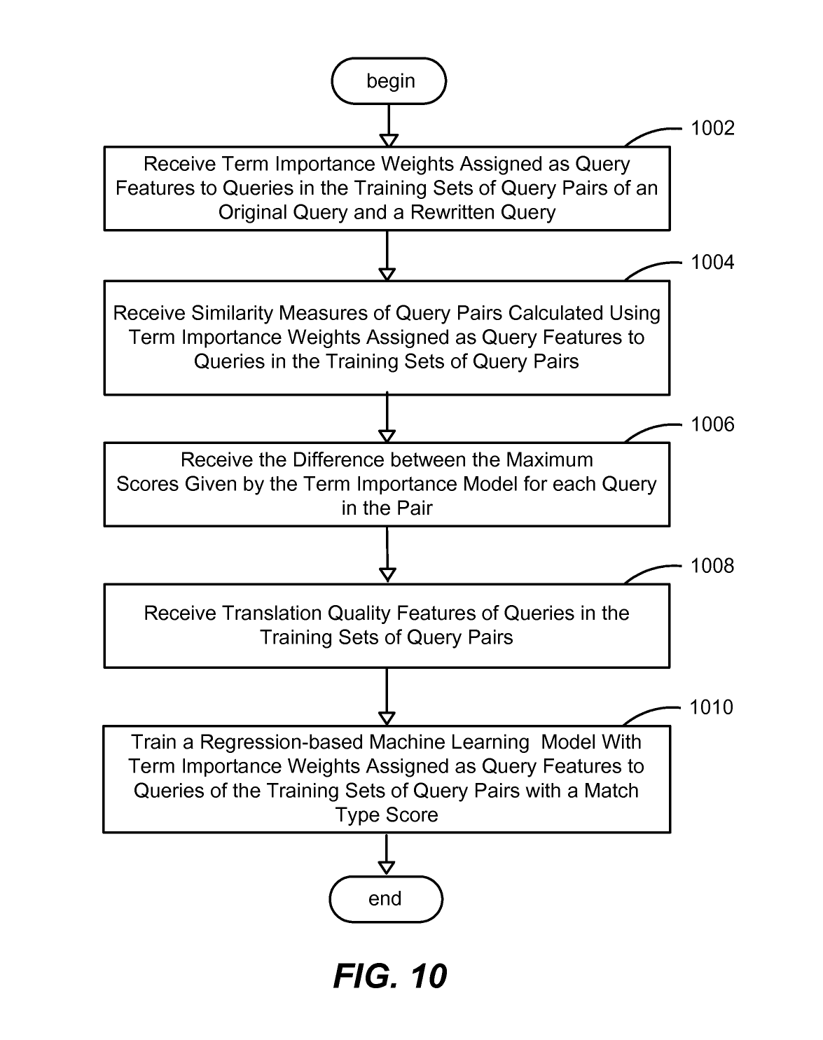

At step 908, term importance weights for queries in the training sets of query pairs of an original query and a rewritten query may be received. The term importance weights may be assigned at step 910 as query features to queries in the training sets of query pairs. At step 912, a model may be trained to predict matching rewritten queries using term importance weights assigned as query features to queries of the training sets of query pairs with a match type score. The steps for training the model are described in further detail below in conjunction with FIG. 10. The model trained using term importance weights assigned as query features to queries of the training sets of query pairs with a match type score may then be output at step 914. In an embodiment, the model may be stored in storage such as advertisement server storage. Given a pair of queries, the model may then be used to predict whether the pair of queries match.

FIG. 10 presents a flowchart generally representing the steps undertaken in one embodiment for training a query term importance model to predict matching rewritten queries using term importance weights assigned as query features to queries of the training sets of query pairs of an original query and a rewritten query with a match type score. At step 1002, term importance weights assigned as query features to queries in the training sets of query pairs of an original query and a rewritten query may be received. Similarity measures of query pairs calculated using term importance weights assigned as query features to queries in the training sets of query pairs of an original query and a rewritten query may be received at step 1004.

At step 1006, the difference between the maximum scores given by a term importance model for each query in the training sets of query pairs of an original query and a rewritten query may be received. Translation quality measures of query pairs calculated using term importance weights assigned as query features to queries in the training sets of query pairs of an original query and a rewritten query may be received at step 1008. And a regression-based machine learning model may be trained with term importance weights assigned as query features to queries of the training sets of query pairs of an original query and a rewritten query with a match type score at step 1010. In an embodiment, the system may be trained to predict binary relevance by considering the two classes labeled as Precise Match and Approximate Match to correspond to a “match” and the two classes labeled as Marginal Match and Clear Mismatch to correspond to a mismatch.

Those skilled in the art will appreciate that the term importance model may include other features such as: the ratio of the length of the original query to that of the rewritten query, the reciprocal of the ratio of the length of the original query to that of the rewritten query, the cosine similarity between a query term vector for q1 and a query term vector q2 using term importance weights as features of the queries, the cosine similarity of vectors obtained from tri-grams of q1 and q2, the cosine similarity between 4-gram vectors obtained from q1 and q2, translation quality based features for q1 and q2 calculated as:

$$Tr ( Q 1 \vert Q 2 ) = {( {\prod }_{{q}_{i} ∈ Q 1} {max}_{{q}_{j} ∈ Q 2} ( p ( {q}_{i} \vert {q}_{j} ) , ɛ ) )}^{\frac{1}{\vert Q \vert}} ,$$

the fraction of untranslated words in the original query, q1, the fraction of untranslated words in the rewritten query, q2, and so forth.

Thus the present invention may use supervised learning of context-dependent term importance for learning better query weights for search engine advertising where the advertisement document may be short and provide scant context in the title, small description, and set of keywords or key phrases that identify the advertisement. The query term importance model predicts the importance of a term in search engine queries better than IDF for advertisement retrieval tasks in a sponsored search system, including query rewriting and selecting more relevant advertisements presented to a user. Moreover, the query term importance model is extensible and may apply other features such as query length, IDF, PMI, bid term frequency, categorization labels, named entities, IR rank moves, single term query ratio, POS, stop, character count ratio, and so forth, to predict term importance. Additional features may also be generated using term importance weights for scoring sponsored advertisements including similarity measures of query-advertisement pairs using term importance weights assigned as query features to queries and translation quality measures of query-advertisement pairs calculated using term importance weights assigned as query features to queries.

Those skilled in the art will appreciate that the context-dependent term importance model may also be applied in search retrieval applications to generate a list of document or web pages for search results. The statistical retrieval framework described in conjunction with FIG. 4 may be applied to find documents such as web pages by determining a relevance score using term importance weights of a search query and IDF weights of terms of documents such as web pages.

As can be seen from the foregoing detailed description, the present invention provides an improved system and method for identifying context-dependent term importance of search queries. A query term importance model is learned using supervised learning of context-dependent term importance for queries and may then be applied for advertisement prediction using term importance weights of query terms as query features. For query rewriting, a query term importance model may predict rewritten queries that match a query with term importance weights assigned as query features. For advertisement prediction, a query term importance model may predict relevant advertisements for a query with term importance weights assigned as query features. Thus the query term importance model may predict the importance of a term in search engine queries better than IDF for advertisement retrieval tasks. As a result, the system and method provide significant advantages and benefits needed in contemporary computing and in search advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for predicting relevant search advertisements, comprising:
a query term importance engine that applies a query term importance model for advertisement prediction that uses a plurality of term importance weights as a plurality of query features and a plurality of inverse document frequency weights of advertisement terms as a plurality of advertisement features to assign a relevance score to a plurality of sponsored advertisements;
a sponsored advertisement selection engine operably coupled to the query term importance engine that selects the plurality of sponsored advertisements scored by the query term importance engine that applies the query term importance model for advertisement prediction; and
a storage operably coupled to the sponsored advertisement selection engine that stores the query term importance model for advertisement prediction that uses the plurality of term importance weights as the plurality of query features and the plurality of inverse document frequency weights of advertisement terms as advertisement features to assign the relevance score to each of the plurality of sponsored advertisements.

2. The system of claim 1 wherein the storage comprises an advertisement server storage that stores the query term importance model.

3. The system of claim 1 further comprising an advertisement serving engine operably coupled to the sponsored advertisement selection engine that serves at least one of the plurality of sponsored advertisements assigned the relevance score by the query term importance model for advertisement prediction.

4. The system of claim 3 further comprising a web browser operably coupled to the advertisement serving engine that displays the at least one of the plurality of sponsored advertisements in a sponsored advertisement area of a search results web page.

5. A computer-implemented method for predicting relevant search advertisements, comprising:
assigning at least one term importance weight from a query term importance model as at least one query feature to a query;
receiving a plurality of sponsored advertisements with inverse document frequency weights assigned as features to a plurality of terms for each sponsored advertisement;
applying a term importance model for advertisement prediction that uses the at least one term importance weight term as the at least one query feature and a plurality of inverse document frequency weights of advertisement terms as advertisement features to assign a relevance score to each of the plurality of sponsored advertisements;
assigning at least one sponsored advertisement of the plurality of sponsored advertisements assigned the relevance score to at least one web page placement in the sponsored advertisements area of the search results web page; and
sending the at least one sponsored advertisement for display on the search results web page in a location of the at least one web page placement in the sponsored advertisement area of the search results web page.

6. The method of claim 5 further comprising receiving a request to serve the at least one sponsored advertisement for display in the sponsored advertisement area of the search results web page.

7. The method of claim 5 further comprising storing the at least one sponsored advertisement for display on the search results web page in the location of the at least one web page placement in the sponsored advertisement area of the search results web page.

8. The method of claim 5 further comprising assigning the relevance score to each of the plurality of sponsored advertisements.

9. The method of claim 8 further comprising ranking the plurality of sponsored advertisements by the relevance score assigned to each of the plurality of sponsored advertisements.

10. The method of claim 5 further comprising receiving by a client device the at least one sponsored advertisement for display on the search results web page in the location of the at least one web page placement in the sponsored advertisement area of the search results web page.

11. The method of claim 5 further comprising displaying by a client device the at least one sponsored advertisement in the location of the at least one web page placement in the sponsored advertisement area of the search results web page.

12. A computer-readable storage medium having computer-executable instructions for performing the steps of:
receiving a plurality of training sets of a training query and a training advertisement with a training relevance score;
receiving a plurality of term importance weights for each training query in the plurality of training sets of the training query and the training advertisement with the training relevance score;
assigning the plurality of term importance weights as a plurality of training query features to each training query in the plurality of training sets of the training query and the training advertisement with the training relevance score;
training a model that uses the plurality of term importance weights as the plurality of training query features and a plurality of inverse document frequency weights of advertisement terms as training advertisement features for each of the plurality of training sets of the training query and the training advertisement to assign a prediction relevance score to each of the plurality of training sets of the training query and the training advertisement; and
outputting the model to assign the prediction relevance score to a plurality of sets of a query and an advertisement using the plurality of term importance weights as a plurality of query features and the plurality of inverse document frequency weights of advertisement terms as advertisement features for each of the plurality of sets of the query and the advertisement.

13. The method of claim 12 further comprising receiving a plurality of similarity measures for each training set of the plurality of training sets of the training query and the training advertisement with the training relevance score, each similarity measure of the plurality of similarity measures calculated as a cosine similarity measure between the plurality of term importance weights as the plurality of training query features and a plurality of inverse document frequency weights of advertisement terms as training advertisement features for each of the plurality of training sets of the training query and the training advertisement.

14. The method of claim 13 further comprising using the plurality of similarity measures for each training set of the plurality of training sets of the training query and the training advertisement with the training relevance score as a plurality of additional features to train the model that uses the plurality of term importance weights as the plurality of training query features and the plurality of inverse document frequency weights of advertisement terms as training advertisement features for each of the plurality of training sets of the training query and the training advertisement to assign the prediction relevance score to each of the plurality of training sets of the training query and the training advertisement.

15. The method of claim 12 further comprising:
receiving a plurality of n-gram features for each training set of the plurality of training sets of the training query and the training advertisement with the training relevance score; and
using the plurality of n-gram features for each training set of the plurality of training sets of the training query and the training advertisement with the training relevance score as a plurality of additional features to train the model that uses the plurality of term importance weights as the plurality of training query features and the plurality of inverse document frequency weights of advertisement terms as training advertisement features for each of the plurality of training sets of the training query and the training advertisement to assign the prediction relevance score to each of the plurality of training sets of the training query and the training advertisement.

16. The method of claim 12 further comprising:
receiving a plurality of string overlap features for each training set of the plurality of training sets of the training query and the training advertisement with the training relevance score; and
using the plurality of string overlap features for each training set of the plurality of training sets of the training query and the training advertisement with the training relevance score as a plurality of additional features to train the model that uses the plurality of term importance weights as the plurality of training query features and the plurality of inverse document frequency weights of advertisement terms as training advertisement features for each of the plurality of training sets of the training query and the training advertisement to assign the prediction relevance score to each of the plurality of training sets of the training query and the training advertisement.

17. The method of claim 12 further comprising:
receiving a plurality of term translation features for each training set of the plurality of training sets of the training query and the training advertisement with the training relevance score; and
using the plurality of term translation features for each training set of the plurality of training sets of the training query and the training advertisement with the training relevance score as a plurality of additional features to train the model that uses the plurality of term importance weights as the plurality of training query features and the plurality of inverse document frequency weights of advertisement terms as training advertisement features for each of the plurality of training sets of the training query and the training advertisement to assign the prediction relevance score to each of the plurality of training sets of the training query and the training advertisement.

18. The method of claim 13 wherein each similarity measure of the plurality of similarity measures calculated as the cosine similarity measure between the plurality of term importance weights as the plurality of training query features and the plurality of inverse document frequency weights of advertisement terms as training advertisement features for each of the plurality of training sets of the training query and the training advertisement comprises in part a cosine similarity measure calculated between the plurality of term importance weights as the plurality of training query features and a plurality of inverse document frequency weights of advertisement terms from an abstract of the training advertisement as training advertisement features for each of the plurality of training sets of the training query and the training advertisement.

19. The method of claim 13 wherein each similarity measure of the plurality of similarity measures calculated as the cosine similarity measure between the plurality of term importance weights as the plurality of training query features and the plurality of inverse document frequency weights of advertisement terms as training advertisement features for each of the plurality of training sets of the training query and the training advertisement comprises in part a cosine similarity measure calculated between the plurality of term importance weights as the plurality of training query features and a plurality of inverse document frequency weights of advertisement terms from a display uniform resource locator of the training advertisement as training advertisement features for each of the plurality of training sets of the training query and the training advertisement.

20. The method of claim 13 wherein each similarity measure of the plurality of similarity measures calculated as the cosine similarity measure between the plurality of term importance weights as the plurality of training query features and the plurality of inverse document frequency weights of advertisement terms as training advertisement features for each of the plurality of training sets of the training query and the training advertisement comprises in part a cosine similarity measure calculated between the plurality of term importance weights as the plurality of training query features and a plurality of inverse document frequency weights of advertisement terms from a title of the training advertisement as training advertisement features for each of the plurality of training sets of the training query and the training advertisement.
